(19) United States
(12) Patent Application Publication
(10) Pub. No.: US 2026/0056358 A1
(43) Pub. Date: Feb. 26, 2026

(54) MULTI-SURFACE WAVEGUIDE TREATMENT

(71) Applicant: Applied Materials, Inc., Santa Clara, CA (US)

(72) Inventors: Simon LORENZO, Santa Clara, CA (US); Kevin MESSER, Mountain View, CA (US); Kunal SHASTRI, Santa Clara, CA (US)

(21) Appl. No.: 19/306,389

(22) Filed: Aug. 21, 2025

Related U.S. Application Data
(60) Provisional application No. 63/686,079, filed on Aug. 22, 2024.

(51) Int. Cl. F21V 8/00

(52) U.S. Cl. CPC G02B 6/0016; G02B 6/0036; G02B 6/0065

(57) ABSTRACT

Embodiments of waveguides are described herein. A waveguide of one or more embodiments includes a waveguide substrate having a first surface, a second surface opposing the first surface, a waveguide substrate sidewall connecting the first surface to the second surface, a grating layer disposed over the first surface, a blackening layer disposed over an exterior portion of the waveguide substrate, and a blackening section disposed on the waveguide substrate sidewall. The grating layer includes at least an input coupling grating and an output coupling grating disposed therein. The grating layer includes an interior portion surrounding the input coupling grating and the output coupling grating.

### CROSS-REFERENCES TO RELATED APPLICATIONS

This application claims benefit of and priority to U.S. Provisional Patent Application Ser. No. 63/686,079, filed on Aug. 22, 2024, which is incorporated herein by reference in its entirety.

### BACKGROUND

### Field

Embodiments of the present disclosure generally relate to waveguides. More specifically, embodiments described herein relate to a waveguide having a blackening layer disposed on an exterior portion of a grating layer and a blackening layer disposed on at least a grating sidewall and a waveguide substrate sidewall.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguides, such as augmented reality waveguides, are used to assist in overlaying images. Generated light is propagated through a waveguide until the light exits the waveguide and is overlaid on the ambient environment. It is desirable to suppress unwanted light leakage and improve image contrast and visual clarity.

Accordingly, what is needed in the art is a waveguide having a blackening layer disposed on an exterior portion of a grating layer and a blackening layer disposed on at least a grating sidewall and a waveguide substrate sidewall.

### SUMMARY

An embodiment of a waveguide is described herein. The waveguide includes a waveguide substrate having a first surface, a second surface opposing the first surface, a waveguide substrate sidewall connecting the first surface to the second surface, a grating layer disposed over the first surface, a blackening layer disposed over an exterior portion of the waveguide substrate, and a blackening section disposed on the waveguide substrate sidewall. The grating layer includes at least an input coupling grating and an output coupling grating disposed therein. The grating layer includes an interior portion surrounding the input coupling grating and the output coupling grating.

Another embodiment of a waveguide is described herein. The waveguide includes a waveguide substrate having a first surface, a second surface opposing the first surface, a waveguide substrate sidewall connecting the first surface to the second surface, a grating layer disposed over the first surface, and a waveguide layer disposed between the grating layer and the waveguide substrate. The grating layer includes at least an input coupling grating and an output coupling grating disposed therein. The grating layer includes an interior portion surrounding the input coupling grating and the output coupling grating. The grating layer further includes an exterior portion disposed over a region of the waveguide substrate adjacent to the waveguide substrate sidewall of the waveguide substrate. The waveguide includes a blackening layer disposed over an exterior portion of the grating layer, and a blackening section disposed on a grating sidewall of the grating layer, on a waveguide layer sidewall of the waveguide layer, and on the waveguide substrate sidewall.

An embodiment of a method is described herein. The method includes applying a formulation to a waveguide and curing the formulation to form an optically absorbent composition. The waveguide includes a waveguide substrate having a first surface and a second surface opposing the first surface. The waveguide further includes a grating layer disposed over the first surface of the waveguide substrate. The grating layer includes at least an input coupling grating and an output coupling grating disposed therein. The grating layer further includes an interior portion surrounding the input coupling grating and the output coupling grating. Further, the grating layer includes an exterior portion disposed over a region of the waveguide substrate adjacent to the waveguide substrate sidewall of the waveguide substrate. During the applying a formulation operation of the method, the formulation is applied to the exterior portion of the grating layer, a grating sidewall of the grating layer, and on the waveguide substrate sidewall of the waveguide substrate. During the curing operation, the optically absorbent composition is formed on the exterior portion of the grating layer, the grating sidewall of the grating layer, and on the waveguide substrate sidewall of the waveguide substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a perspective, top view of a waveguide, according to one or more embodiments disclosed herein.

FIGS. 2A and 2B illustrate schematic, cross-sectional views of a waveguide according to one or more embodiments disclosed herein.

FIGS. 3A and 3B illustrate schematic, cross-sectional views of a waveguide according to one or more embodiments disclosed herein.

FIG. 4 illustrates a flow diagram of a method of forming an optically absorbent composition on a waveguide according to one or more embodiments disclosed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to a waveguide having at least one surface partially coated with a blackening section and a method of disposing the blackening section over the waveguide. In some embodiments, blackening sections are disposed over portions of the surface and a blackening layer is disposed on a sidewall of the substrate. In other embodiments, a blackening section is disposed around the circumference of the surface. A blackening layer disposed over a portion of the surface and a blackening section disposed on the sidewall of the substrate can allow the substrate and the blackening layer, or the substrate and the blackening section, to have different refractive indices. For example, the substrate can have a refractive index that is higher than the refractive index of the blackening layer, thereby allowing for commercially available blackening layers to be used during manufacturing, reducing costs and increasing scalability.

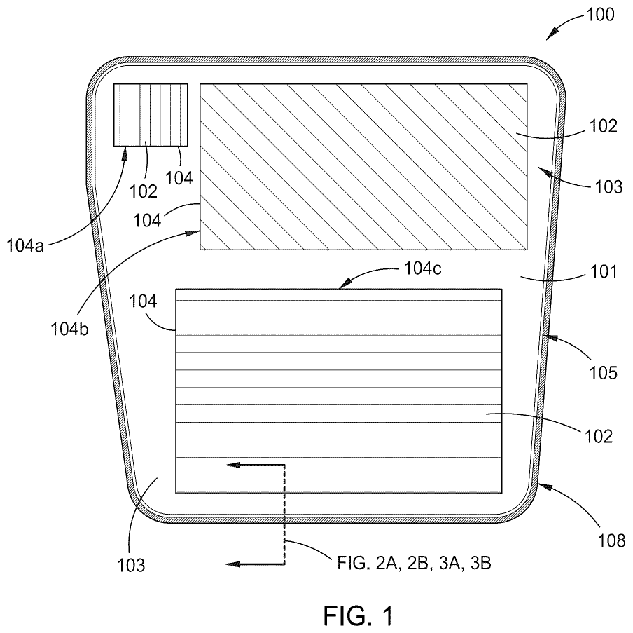

FIG. 1 illustrates a perspective, top view of a waveguide 100. It is to be understood that the waveguide 100 described herein is an exemplary waveguide and that other waveguides may be used with or modified to accomplish aspects of the present disclosure. The waveguide 100 includes a plurality of structures 102. The structures 102 may be disposed over, under, or on a first surface 103 of a waveguide substrate 101, or disposed in the waveguide substrate 101. The structures 102 are nanostructures and have a sub-micron critical dimension, e.g., a width less than 1 micrometer.

In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating.

The waveguide substrate 101 can be any substrate used in the art, and can be either opaque or transparent to a chosen wavelength of light, depending on the use of the waveguide substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the waveguide substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof.

In other embodiments, which can be combined with other embodiments described herein, the waveguide substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the waveguide substrate 101 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof. The waveguide substrate 101 may have a refractive index greater than about 1.8. For example, the waveguide substrate 101 includes lithium niobate.

The structures 102 include a structure material. The structure material and the waveguide substrate 101 include a different material. The structure material includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the structure material include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

In operation of the waveguide 100 a virtual image is projected from a near-eye display, such as a microdisplay, to the first grating 104a. The structures 102 of the first grating 104a in-couple the incident beams of light of the virtual image and diffract the incident beams to the second grating 104b. The diffracted beams undergo total-internal-reflection (TIR) through the waveguide 100 until the diffracted beams contact structures 102 of the second grating 104b. The diffracted beams from the first grating 104a incident on the second grating 104b are split into a first portion of beams refracted back or lost in the waveguide 100, a second portion beams that undergo TIR in the second grating 104b until the second portion beams contact another structure of the plurality of structures 102 of the second grating 104b, and a third portion of beams that are transmitted through the waveguide 100 to the third grating 104c. The beams of the second portion of beams that undergo TIR in the second grating 104b continue to contact structures of the plurality of structures 102 until either the intensity of the second portion of beams coupled through the waveguide 100 to the second grating 104b is depleted, or remaining portion of the second portion of beams propagating through the second grating 104b reach the end of the second grating 104b.

The beams pass through the waveguide 100 to the third grating 104c and undergo TIR in the waveguide 100 until the beams contact a structure of the plurality of gratings 104 of the third grating 104c. The beams are split into beams that are refracted back or lost in the waveguide 100. Beams undergo TIR in the third grating 104c until the beams contact another structure of the plurality of gratings 104 or the beams are out-coupled from the waveguide 100. The beams that undergo TIR in the third grating 104c continue to contact structures of the plurality of gratings 104 until either the intensity of the beams pass through the waveguide 100 to the third grating 104c is depleted, or a remaining portion of the beams propagating through the third grating 104c have reached the end of the third grating 104c. The beams of the virtual image are propagated from the third grating 104c to overlay the virtual image over the ambient environment.

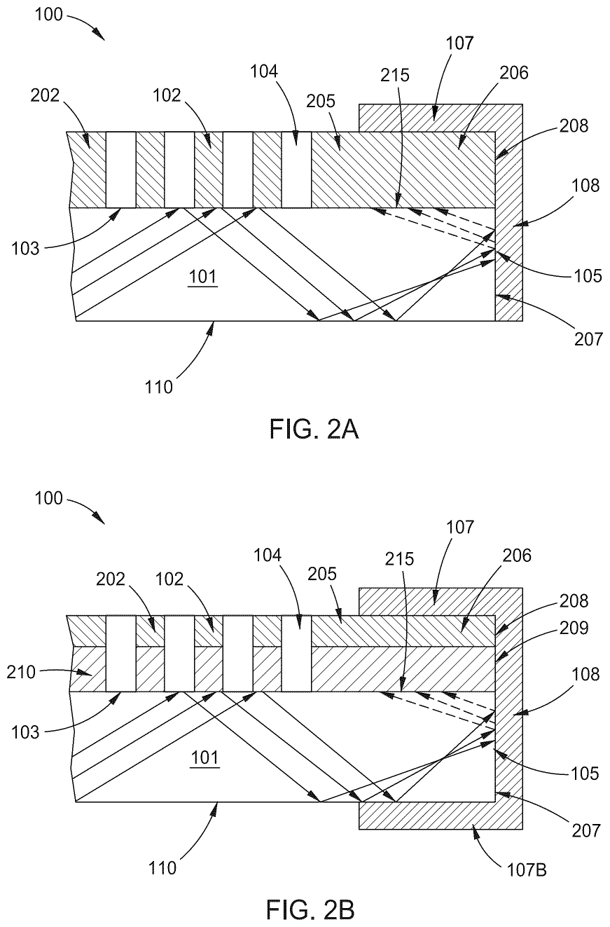

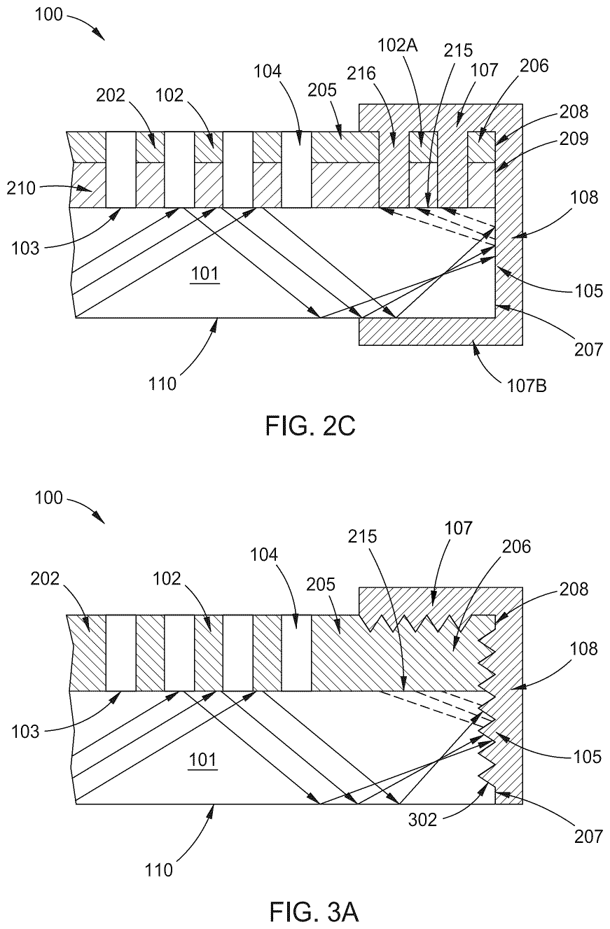

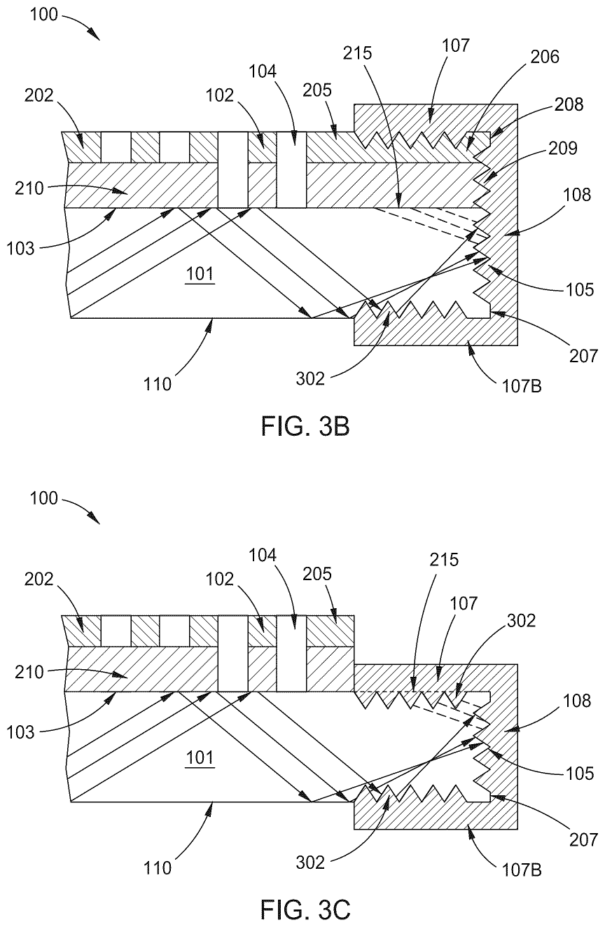

Some light provided to the waveguide 100 strays from the intended path discussed above. For example, in some instances, a fraction of beams, i.e., stray light, reaches a sidewall 105 of the waveguide 100. The sidewall 105 may be an outer sidewall of the waveguide 100 such that the gratings 104 are positioned inside the sidewall 105. The sidewall 105 may include any combination of the waveguide substrate sidewall 207, the grating sidewall 208, and the waveguide layer sidewall 209. Upon reaching the sidewall 105, the stray light may be transmitted through the sidewall 105 of the waveguide 100. In some embodiments, the stray light is reflected or scattered through the waveguide 100 at a variety of angles or absorbed at the sidewall 105. Stray light that is transmitted through the sidewall 105 and/or stray light that is scattered from the sidewall 105 through the waveguide 100 reduces the quality of virtual image via noise from the stray light. To reduce the amount of stray light transmitted through the sidewall 105 and the amount of stray light scattered in the waveguide 100 by the sidewall 105 the waveguide 100 includes an optically absorbent composition, as shown in FIGS. 2A-2B and 3A-3B. An optically absorbent composition prevents light from bouncing back into the waveguide 100 after hitting the sidewall 105. If light bounces back into the waveguide 100 it will negatively affect the performance of the waveguide 100 because it causes a low contrast. The optically absorbent composition may be disposed over the sidewall 105, the first surface 103, and/or the second surface 110. The second surface 110 is disposed on the opposite side of the waveguide 100 as the first surface 103. The optically absorbent composition disposed over the sidewall 105 is a blackening section 108. The optically absorbent composition disposed over the first surface 103 or the second surface 110 is a blackening layer 107.

The optically absorbent composition includes one or more types of particles, at least one of one or more dyes or one or more pigments, and a polymer matrix of one or more binders.

The one or more types of particles may include nanoparticles, microparticles, or combinations thereof. A nanoparticle may have a diameter from about 1 to about 100 nanometers. A microparticle may have a diameter from about 1 micrometer to 1000 micrometers. The inclusion of particles in the optically absorbent composition increases the optical density of the optically absorbent composition. The optically absorbent composition may have an optical density of about 2.0 or greater. In some embodiments, the optical density of the optically absorbent composition is from about 1.0 to about 3.0. In some embodiments, the optical density of the optically absorbent composition is from about 4.0 to about 6.0.

The one or more types of particles include, but are not limited to, titanium oxide (TiO₂), Si, zirconium oxide (ZrO₂), zinc oxide (ZnO), ferrosoferric oxide (Fe₃O₄), germanium (Ge), SiC, diamond, dopants thereof, or any combination thereof. The one or more types of particles includes at least of nanoparticles or microparticles. Each nanoparticle (NP) or microparticle (MP) can be a coated particle, such as a particle having one, two, or two or more shells disposed around a core. In some examples, the NPs or MPs can contain one or more types of ligands coupled to the outer surface of the NPs or MPs (e.g., ligated NPs or stabilized NPs). The NPs or MPs can have one or more different shapes or geometries, such as spherical, oval, rod, cubical, wire, cylindrical, rectangular, or combinations thereof.

The NPs can have a size or a diameter of about 2 nm, about 5 nm, about 8 nm, about 10 nm, about 12 nm, about 15 nm, about 20 nm, about 25 nm, about 30 nm, or about 35 nm to about 40 nm, about 50 nm, about 60 nm, about 80 nm, about 100 nm, about 150 nm, or about 200 nm. For example, the NPs can have a size or a diameter of about 2 nm to about 200 nm, about 2 nm to about 150 nm, about 2 nm to about 100 nm, about 2 nm to about 80 nm, about 2 nm to about 60 nm, about 2 nm to about 50 nm, about 2 nm to about 40 nm, about 2 nm to about 30 nm, about 2 nm to about 20 nm, about 2 nm to about 15 nm, about 2 nm to about 10 nm, about 10 nm to about 200 nm, about 10 nm to about 150 nm, about 10 nm to about 100 nm, about 10 nm to about 80 nm, about 10 nm to about 60 nm, about 10 nm to about 50 nm, about 10 nm to about 40 nm, about 10 nm to about 30 nm, about 10 nm to about 20 nm, about 10 nm to about 15 nm, about 50 nm to about 200 nm, about 50 nm to about 150 nm, about 50 nm to about 100 nm, about 50 nm to about 80 nm, or about 50 nm to about 60 nm.

A particle refractive index of the one or more types of particles is greater than 1.5. In some embodiments, which can be combined with other embodiments described herein, the particle refractive index of the one or more types of particles is about 1.7 or greater, about 2.0 or greater, or about 2.4 or greater. A particle refractive index greater than 2.0 provides for the optically absorbent composition having a refractive index of about 1.7 or greater. A particle refractive index greater than 1.7 provides for the optically absorbent composition having a refractive index of about 1.5 or greater. In one or more embodiments, the optically absorbent composition has a refractive index of 2.0 or greater. The optical density of the optically absorbent composition of about 2.0 or greater is provide by the at least one of one or more dyes or one or more pigments. The refractive index of about 1.5 or greater and the optical density of about 2.0 or greater reduces the amount of stray light transmitted through the sidewall 105 and the amount of stray light scattered in the waveguide 100 by the sidewall 105. The refractive index of about 1.5 or greater of the optically absorbent composition is matched to high refractive index substrates, i.e., the waveguide substrate 101 having a refractive index greater than about 1.8, to provide for further absorption of stray light.

Examples of the dyes include organic dyes. The one or more pigments include, but are not limited to, carbon black, carbon nanotubes, iron oxide black, black pigments, or combinations thereof. The one or more binders are operable to be cured by radiation to form a polymer matrix. The one or more types of particles are disposed in the polymer matrix. The one or more binders include, but are not limited to, a UV curable binder, a LED curable binder, a thermal curable binder, an infrared curable binder, or combinations thereof.

The optically absorbent composition may further include one or more solvents, one or more filler dispersions, one or more photoinitiators, one or more epoxy resins, one or more additives, one or more silanes, one or more isocyanates, one or more acids, one or more phosphine oxides, or combinations thereof. The one or more solvents are operable to evaporate or vaporize upon application on the formulation to the waveguide 100. Examples of the filler dispersions include acrylates or methacrylates. Examples of the additives include amines or amides.

The optically absorbent composition provides for a viscosity, surface tension, chemical and physical stability, and environmental reliability such that the optically absorbent composition is operable to be applied to the sidewall 105, first surface 103, and/or second surface 110 with an edge blackening tool and remain on the sidewall 105, first surface 103, and/or second surface 110 prior to curing. The optically absorbent composition has a viscosity of about 1 kcP to 100 kcP.

The blackening layer 107 can be formed from an optically absorbent composition having a refractive index that is different from the substrate refractive index, thereby allowing manufacturing of the waveguide 100 to utilize a larger selection of optically absorbent compositions compared to conventional waveguide combiners. The light will leave the waveguide 100 and enter the blackening layer 107 because there is no optical discontinuity between the two materials. Additionally, the blackening layer 107 acts to absorb the light, which prevents the light from bouncing back into the waveguide 100.

The optically absorbent composition of the blackening section 108 and the blackening layer 107 has a refractive index that is different than the refractive index of the waveguide substrate 101. In some embodiments, which may be combined with other embodiments described herein, the waveguide substrate 101 has a substrate refractive index greater than 1.4. In some embodiments, the optically absorbent composition has a refractive index greater than 1.5. For example, the optically absorbent composition may have a refractive index of 1.7 or greater, 1.9 or greater, or 2.1 or greater. In some embodiments, the optically absorbent composition has a refractive index from about 1.7 to about 2.1, from about 1.6 to about 2.0, from about 1.5 to about 1.9, or from about 1.7 to about 1.9. In some embodiments, the refractive index of the optically absorbent composition is less than about 0.1% to about 50% of the refractive index of the waveguide substrate 101. In one or more embodiments, the optically absorbent composition has a refractive index of 2.0 or greater.

The optically absorbent composition forms the blackening layer 107 on the first surface 103 of the waveguide substrate 101, as shown in FIGS. 2A and 3A. The waveguide substrate 101 includes a first surface 103. The waveguide substrate 101 includes a second surface 110 opposing the first surface 103. The waveguide substrate 101 includes a waveguide substrate sidewall 207 connecting the first surface 103 to the second surface 110.

A grating layer 202 is disposed over the first surface 103 of the waveguide substrate 101. The grating layer 202 includes at least two gratings 104 disposed therein. In one or more embodiments, the grating layer 202 includes an input coupling grating and an output coupling grating disposed therein. The grating layer 202 includes an interior portion 205 defining the gratings 104. The interior portion 205 may also surround the gratings 104. The grating layer 202 includes a grating sidewall 208. The grating sidewall 208 is disposed adjacent to the waveguide substrate sidewall 207. In one or more embodiments, the grating sidewall 208 is substantially planar to the sidewall 105 of the waveguide 100. In one or more embodiments, the grating sidewall 208 is substantially planar to the waveguide substrate sidewall 207. The grating layer 202 includes an exterior portion 206 disposed over a region of the waveguide substrate 101 adjacent to the waveguide substrate sidewall 207 of the waveguide substrate 101. In one or more embodiments, the exterior portion 206 is disposed adjacent to the grating sidewall 208. In one or more embodiments, the exterior portion 206 of the grating layer 202 is disposed over an exterior portion 215 of the waveguide substrate 101.

The grating layer 202 may be made of one or more of silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), titanium silicon oxide (TiSiOx), or silicon carbon-nitride (SiCN) containing materials.

In one or more embodiments, a waveguide layer 210 is disposed between the grating layer 202 and the waveguide substrate 101. The waveguide layer 210 includes a waveguide layer sidewall 209. The waveguide layer sidewall 210 is disposed adjacent to the waveguide substrate sidewall 207 and the grating layer sidewall 208.

The waveguide layer 210 may be made of one or more of silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), titanium silicon oxide (TiSiOx), or silicon carbon-nitride (SiCN) containing materials. The grating layer 202 and the waveguide layer 210 have different compositions. In one or more embodiments, the grating layer 202 is made of niobium oxide and the waveguide layer 210 is made of titanium oxide.

The waveguide 100 may include gratings 104 disposed in only the grating layer 202, as shown in FIGS. 2A and 3A. The waveguide 100 may include gratings 104 disposed in both the grating layer 202 and the waveguide layer 210, as shown in FIG. 2B. The waveguide 100 may include one or more gratings 104 disposed in both the grating layer 202 and the waveguide layer 210 as well as one or more gratings 104 disposed in only the grating layer 202 as shown in FIG. 3B. It should be noted that any of the combinations disclosed herein may be combined together and are not limited to the embodiments shown in the Figures. For example, the blackening layer 107 may be disposed on the second surface 110 as shown in FIG. 2B and include gratings 104 disposed only in the grating layer 202 as shown in FIG. 2A.

The grating layer 202 may have a thickness substantially the same as the thickness of the waveguide layer 210. In one or more embodiments, the grating layer 202 has a thickness less than the thickness of the waveguide layer 210. In one or more embodiments, the grating layer 202 has a thickness greater than the thickness of the waveguide layer 210.

In one or more embodiments, the blackening layer 107 may be disposed over a portion of the grating layer 202. In these embodiments, the portion of the grating layer 202 that the blackening layer 107 is disposed over begins from the sidewall 105 and extends towards the interior of the waveguide 100. At least a portion of the blackening layer 107 contacts the blackening section 108. In one or more embodiments, the blackening layer 107 is disposed over the exterior portion 206. The blackening layer 107 may be disposed over from about 1% to about 20% of the total surface area of the waveguide 100.

The optically absorbent composition may be disposed on the second surface 110 of the waveguide substrate 101 to form a blackening layer 107B, as shown in FIGS. 2B and 3B. The blackening layer 107 may be disposed on a portion of the second surface 110. The portion of the second surface 110 that the blackening layer 107B is disposed over begins from the sidewall 105 and extends towards the interior of the waveguide 100. The blackening layer 107B may be disposed over from about 1% to about 20% of the total surface area of the waveguide 100. The blackening layer 107B disposed over the second surface 110 may be disposed over a substantially equivalent portion of the total surface area of the waveguide 100 as the blackening layer 107 disposed over the first surface 103.

Additionally, and/or alternatively, the optically absorbent composition may be disposed on the sidewall 105 of the waveguide substrate 101. The optically absorbent composition, when cured, forms the blackening section 108. The blackening section 108 may be disposed on the grating sidewall 208. The blackening section 108 may be disposed on the waveguide substrate sidewall 207. The blackening section 108 may be disposed on the waveguide layer sidewall 210.

The optically absorbent composition may be cured by exposing the optically absorbent composition to UV light, heat, and/or chemicals. The blackening section 108 provides further assistance in reducing stray light transmitted through the waveguide. The blackening section 108 captures stray light as it bounces at different angles within the waveguide 100. Stay light is captured wherever a blackening section 108 has been applied on the sidewall 105.

To obtain the blackening refractive index, the optically absorbent composition includes a blackening ink, a siloxane-containing resin, or combinations thereof. The optically absorbent composition includes, but is not limited to, one or more dyes, one or more pigments, a polymer mix of one or more binders, or combinations thereof. The optically absorbent composition may further include one or more filler dispersions, one or more photoinitiators, one or more epoxy resin, one or more additives, one or more silanes, one or more isocyanates, one or more acids, one or more phosphine oxides, or combinations thereof.

FIGS. 2A and 2B illustrate schematic, cross-sectional views of a waveguide 100. The waveguides 100 of FIGS. 2A and 2B have a blackening layer 107 and a blackening section 108. As shown in FIG. 2A, the blackening section 108 is disposed over the waveguide substrate sidewall 207. The blackening layer 107 is disposed over at least the first surface 103 between the gratings 104 and the waveguide substrate sidewall 207 of the waveguide substrate 101 and contacts the blackening section 108. In some embodiments, which can be combined with other embodiments, the blackening layer 107 extends over the first surface 103 for a distance that is greater than or equal to about 1 pupil bounce to about 10 pupil bounces, e.g., about 0.1 mm to about 30 mm. In some embodiments, the blackening layer 107 is disposed on the second surface 110 of the waveguide substrate 101. In some embodiments, which can be combined with other embodiments, the blackening layer 107 extends over the second surface 110 for a distance that is greater than or equal to about 1 pupil bounce to about 10 pupil bounces, e.g., about 0.1 mm to about 30 mm. The blackening section 108 and the blackening layer 107 reduce the amount of stray light transmitted through the sidewall 105 or peripheral of the first surface 103 and the amount of stray light scattered in the waveguide 100 to the sidewall 105 or peripheral of the first surface 103.

Disposing both a blackening section 108 and one or more blackening layers 107 improves the absorption of unwanted light when the refractive index of the optically absorbent composition is less than the refractive index of the waveguide substrate 101. In embodiments utilizing only a blackening section 108 disposed over the waveguide substrate sidewall 207 of the waveguide substrate 101, the blackening section 108 does not absorb all of the light. Much of the light is reflected and scattered through the waveguide substrate 101, where the light may escape and scatter to distort image quality. Accordingly, including one or more blackening layers 107 disposed on either the first surface 103 and/or the second surface 110 improves the absorption of light and prevents the internal scattering of light within the waveguide substrate 101. For example, a waveguide substrate 101 may have a refractive index of 2.0 and the optically absorbent composition may have a refractive index less than the refractive index of the waveguide substrate 101. In some embodiments, the optically absorbent composition may have a refractive index of 1.5 or greater, 1.7 or greater, or 1.9 or greater. In one or more embodiments, the optically absorbent composition has a refractive index of 2.0 or greater. The greater the refractive index of the optically absorbent composition, the greater the absorption of stray light within the waveguide 100. In these embodiments, a portion of the light may not be absorbed by the blackening section 108 and instead reflects to another section of the waveguide substrate 101. Including a blackening layer 107 on the first surface 103 and/or the second surface 110 improves the portion of the light that is absorbed. Accordingly, the use of both a blackening section 108 and one or more blackening layers 107 enables the use of optically absorbent compositions with a refractive index less than the refractive index of the waveguide substrate 101.

FIG. 2C illustrates schematic, cross-sectional views of a waveguide 100. The waveguide 100 of FIG. 2C includes a blackening layer 107 disposed over the exterior portion 206 and the interior portion 205. The blackening layer 107 may be disposed over one or more auxiliary structures 102A. In these embodiments, the blackening layer 107 is disposed in the space 216 between adjacent auxiliary structures 102A. In one or more embodiments, the space 216 is defined by an auxiliary structure 102A adjacent to a portion of the grating layer 202. In one or more embodiments, the space 216 is defined by an auxiliary structure 102A adjacent to a structure 102. In one or more embodiments, the blackening layer 107 contacts a portion of the first surface 103 of the waveguide substrate 101. It should be noted that the embodiment described in FIG. 2C may be combined with other embodiments described herein. For example, the blackening layer 107 may be disposed over and in the gratings 104 of a waveguide 100 including a portion with a roughened surface as shown in FIGS. 3A-3C.

FIGS. 3A and 3B illustrate schematic, cross-sectional views of a waveguide 100. The waveguides 100 of FIGS. 3A and 3B include a portion with a roughened surface 302. The waveguide 100 of FIGS. 3A and 3B includes a roughened surface 302 over at least the grating sidewall 208 and the waveguide substrate sidewall 207. In embodiments including a waveguide layer 210, the waveguide layer sidewall 209 has a roughened surface 302. As shown in FIG. 3A, the blackening section 108 is disposed over at least the grating sidewall 208 and the waveguide substrate sidewall 207. In embodiments including a waveguide layer 210, the blackening section 108 is disposed over the waveguide layer sidewall 209.

In some embodiments, the roughened surface 302 is non-uniform, e.g., substantially non-planar. The roughened surface 302 may be a portion of the first surface 103, the second surface 110, or the waveguide substrate sidewall 207. The roughened surface 302 may be a portion of any surface of the grating layer 202, including, but not limited to, the grating sidewall 208, the exterior portion 206, or the interior portion 205. The blackening section 108 is disposed on the roughened surface 302, in which the blackening section 108 fills the one or more non-uniformities and/or cavities of the roughened surface 302 of the waveguide substrate sidewall 207. The blackening layer 107 is disposed on the edge surface 302, in which the blackening layer 107 fills the one or more non-uniformities and/or cavities of the roughened surface 302 of the first surface 103 and/or the second surface 110. For example, the roughened surface 302 can include non-uniformities and/or cavities of about 0.1 μm to about 10 μm. The non-uniformities of the roughened surface 302 may promote the scattering of light throughout the waveguide 100. A blackening section 108 that fills the one or more non-uniformities and/or cavities of the roughened surface 302 can further reduce reflections and/or stray light from undergoing total internal reflectance.

As shown in FIG. 3B, the blackening layer 107 is disposed on the second surface 110 of the waveguide substrate 101. In some embodiments, the second surface 110 is non-uniform, e.g., substantially non-planar. The blackening layer 107 is disposed on the second surface 110, in which the blackening layer 107 fills the one or more non-uniformities and/or cavities of the second surface 110. For example, the second surface 110 can include non-uniformities and/or cavities of about 0.1 μm to about 10 μm. A blackening layer 107 that fills the one or more non-uniformities and/or cavities of the second surface 110 can further reduce reflections and/or stray light from undergoing total internal reflectance. The blackening section 108 and the blackening layer 107 reduce the amount of stray light transmitted through the sidewall 105, the peripheral of the first surface 103, and/or the peripheral of the second surface 110, and the amount of stray light scattered in the waveguide 100 to the sidewall 105, peripheral of the first surface 103, and/or the peripheral of the second surface 110.

FIG. 3C illustrates schematic, cross-sectional views of a waveguide 100. The waveguide 100 of FIG. 3C includes a blackening layer 107 disposed on or over an exterior portion 215 of the first surface 103 of the waveguide substrate 101. The blackening layer 107 fills the one or more non-uniformities and/or cavities of the first surface 103.

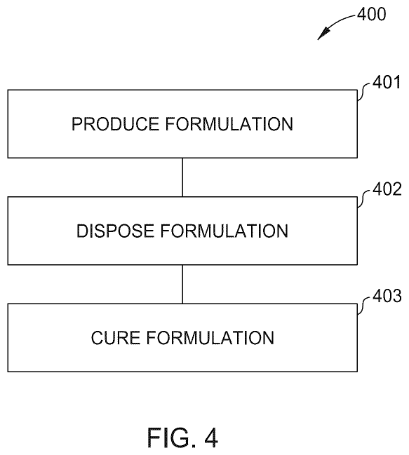

FIG. 4 is a flow diagram of a method 400 of forming an optically absorbent composition on a waveguide substrate sidewall 207, the grating sidewall 208, the exterior portion 206, the waveguide layer sidewall 209 (in embodiments including the waveguide layer sidewall 209), the second surface 110, or any combinations thereof. To facilitate explanation, the method 400 will be described with reference to the waveguide 100 of FIGS. 1-3B. However, it is to be noted that the waveguide 100 is an exemplary waveguide and other waveguides may have a sidewall coated with the optically absorbent composition in conjunction with method 400.

At operation 401, a formulation is produced. The formulation includes one or more types of particles, at least one of one or more dyes or one or more pigments, one or more binders, and one or more solvents. The formulation may further include one or more filler dispersions, one or more photoinitiators, one or more epoxy resins, one or more additives, one or more silanes, one or more isocyanates, one or more acids, one or more phosphine oxides, or combinations thereof. The one or more solvents are operable to evaporate or vaporize upon application on the formulation to the waveguide substrate sidewall 207, the grating sidewall 208, the exterior portion 206, the waveguide layer sidewall 209 (in embodiments including the waveguide layer sidewall 209), the second surface 110, or any combinations thereof. The formulation provides for a viscosity, surface tension, chemical and physical stability, and environmental reliability such that the formulation is operable to be applied to the waveguide substrate sidewall 207, the grating sidewall 208, the exterior portion 206, the waveguide layer sidewall 209 (in embodiments including the waveguide layer sidewall 209), the second surface 110, or any combinations thereof with an edge blackening tool and remain on the waveguide substrate sidewall 207, the grating sidewall 208, the exterior portion 206, the waveguide layer sidewall 209 (in embodiments including the waveguide layer sidewall 209), the second surface 110, or any combinations thereof prior to curing. The formulation has a viscosity of about 1 kcP to 100 kcP.

At operation 402, the formulation is applied. The formulation is applied to the waveguide substrate sidewall 207 and the grating sidewall 208. The formulation is also applied to the exterior portion 206 of the grating layer 202. In embodiments including a waveguide layer 210, the formulation is disposed over the waveguide layer sidewall 209. In one or more embodiments, the formulation is applied to a portion of the second surface 110. The formulation may be applied with an edge blackening tool. In one example, the edge blackening tool includes a substrate support operable to retain an optical device substrate, a first actuator configured to rotate the substrate support, and a holder configured to hold a coating applicator against the waveguide substrate sidewall 207, the grating sidewall 208, the exterior portion 206, the waveguide layer sidewall 209 (in embodiments including the waveguide layer sidewall 209), the second surface 110, or any combinations thereof. When the waveguide substrate 101 is rotated on the substrate support, a second actuator is operable to apply a force on the holder in a direction towards the substrate support to apply the formulation to the waveguide substrate sidewall 207, the grating sidewall 208, the exterior portion 206, the waveguide layer sidewall 209 (in embodiments including the waveguide layer sidewall 209), the second surface 110, or any combinations thereof.

The one or more solvents evaporate or vaporize and the one or more types of particles, at least one of one or more dyes or one or more pigments, one or more binders remain. At operation 403, the formulation is cured. The formulation is cured to form the optically absorbent composition on the waveguide substrate sidewall 207, the grating sidewall 208, the exterior portion 206, the waveguide layer sidewall 209 (in embodiments including the waveguide layer sidewall 209), the second surface 110, or any combinations thereof. The one or more binders are cured by radiation to form a polymer matrix. The one or more types of particles are disposed in and supported by the polymer matrix. The one or more binders include, but are not limited to, a UV curable binder, a LED curable binder, a thermal curable binder, an infrared curable binder, or combinations thereof. Thus, the cure process of operation 403 includes a UV cure process, an LED cure process, a thermal cure process, an infrared cure process, or a combination thereof.

Overall, embodiments of the present disclosure generally provide waveguide combiners having optically absorbent compositions on a sidewall and at least a first side of the waveguide combiner. The optically absorbent compositions can improve the contrast of the waveguide combiners, thereby enabling less than index-matched optically absorbent compositions to be used with high refractive index, e.g., greater than 2.0, substrates, while maintaining sufficient absorption and display contrast. Moreover, the reduced refractive index of the optically absorbent composition can provide a more stable and compatible manufacturing process compared to conventional optically absorbent compositions, thereby reducing costs and increasing scalability during manufacturing.

Any one or more components of the various embodiments disclosed herein may be integrally formed together, directly coupled together, and/or indirectly coupled together and are not limited to the specific arrangement of components illustrated in FIGS. 1-4. Any one or more of the components, embodiments, or steps of the embodiments disclosed herein may be combined in whole or part with any other components, embodiments, or steps of the embodiments disclosed herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below.

Certain embodiments and features have been described using the term “about” with a numerical value. When the term “about” is used in conjunction with a numerical value, it should be construed as indicating any numerical value within 10% of the stated numerical value.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
a waveguide substrate having a first surface and a second surface opposing the first surface, the waveguide substrate having a waveguide substrate sidewall connecting the first surface to the second surface;
a grating layer disposed over the first surface of the waveguide substrate, the grating layer having:
at least an input coupling grating and an output coupling grating disposed therein; and
an interior portion surrounding the input coupling grating and the output coupling grating;
a blackening layer disposed over an exterior portion of the waveguide substrate; and
a blackening section disposed on the waveguide substrate sidewall of the waveguide substrate.

2. The waveguide of claim 1, wherein the grating layer further comprises an exterior portion disposed over a region of the waveguide substrate adjacent to the waveguide substrate sidewall of the waveguide substrate and a grating sidewall disposed adjacent to the waveguide substrate sidewall, and wherein the blackening layer is disposed on the exterior portion of the grating layer and the blackening section is disposed on the grating sidewall.

3. The waveguide of claim 1, further comprising a blackening layer disposed over a second surface of the waveguide substrate.

4. The waveguide of claim 1, further comprising a roughened surface.

5. The waveguide of claim 1, further comprising a waveguide layer disposed between the grating layer and the waveguide substrate, wherein:
the grating layer and the waveguide layer have different compositions; and
the blackening section is further disposed on a waveguide layer sidewall.

6. The waveguide of claim 5, wherein the grating layer comprises niobium oxide and the waveguide layer comprises titanium oxide.

7. The waveguide of claim 6, wherein one or more gratings are disposed in the grating layer and the waveguide layer.

8. The waveguide of claim 1, wherein the waveguide substrate comprises silicon (Si), silicon dioxide (SiO2), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO3), lithium niobate (LiNbO3), or combinations thereof.

9. The waveguide of claim 1, wherein the blackening layer and the blackening section include an optically absorbent composition.

10. The waveguide of claim 9, wherein the optically absorbent composition comprises:
one or more particles;
at least one of one or more dyes or one or more pigments; and
a polymer matrix of one or more binders.

11. The waveguide of claim 10, wherein one or more of the particles are coated particles having a shell disposed around a core.

12. The waveguide of claim 10, wherein one or more of the particles contain one or more types of ligands coupled to an outer surface of the particles.

13. The waveguide of claim 9, wherein the optically absorbent composition further comprises one or more filler dispersions, one or more photoinitiators, one or more epoxy resins, one or more additives, one or more silanes, one or more isocyanates, one or more acids, one or more phosphine oxides, or combinations thereof.

14. The waveguide of claim 9, wherein the optically absorbent composition has an optical density of 2.0 or greater.

15. The waveguide of claim 10, wherein one or more of the particles comprise titanium oxide (TiO2), silicon (Si), zirconium oxide (ZrO2), zinc oxide (ZnO), ferrosoferric oxide (Fe3O4), germanium (Ge), silicon carbide (SiC), diamond, dopants thereof, or any combination thereof.

16. A waveguide, comprising:
a waveguide substrate having a first surface and a second surface opposing the first surface, the waveguide having a waveguide substrate sidewall connecting the first surface to the second surface;
a grating layer disposed over the first surface of the waveguide substrate, the grating layer having:
at least an input coupling grating and an output coupling grating disposed therein;
an interior portion surrounding the input coupling grating and the output coupling grating; and
an exterior portion disposed over a region of the waveguide substrate adjacent to the waveguide substrate sidewall of the waveguide substrate;
a waveguide layer disposed between the grating layer and the waveguide substrate;
a blackening layer disposed on the exterior portion of the grating layer; and
a blackening section disposed on a grating sidewall of the grating layer, on a waveguide layer sidewall of the waveguide layer, and on the waveguide substrate sidewall of the waveguide substrate.

17. A method, comprising:
applying a formulation to a waveguide, the waveguide having:
a waveguide substrate having a first surface and a second surface opposing the first surface, the waveguide having a waveguide substrate sidewall connecting the first surface to the second surface; and
a grating layer disposed over the first surface of the waveguide substrate, the grating layer having:
at least an input coupling grating and an output coupling grating disposed therein;
an interior portion surrounding the input coupling grating and the output coupling grating, and
an exterior portion disposed over a region of the waveguide substrate adjacent to the waveguide substrate sidewall of the waveguide substrate, wherein the formulation is applied to the exterior portion of the grating layer, a grating sidewall of the grating layer, and on the waveguide substrate sidewall of the waveguide substrate; and
curing the formulation to form an optically absorbent composition on the exterior portion of the grating layer, the grating sidewall of the grating layer, and on the waveguide substrate sidewall of the waveguide substrate.

18. The method of claim 17, wherein the formulation is cured by a UV cure process, an LED cure process, a thermal cure process, an infrared cure process, or any combination thereof.

19. The method of claim 17, wherein the optically absorbent composition comprises a refractive index of 1.7.

20. The method of claim 17, wherein the optically absorbent composition comprises a refractive index less than the refractive index of the waveguide substrate.
